(19) United States
(12) Patent Application Publication
(10) Pub. No.: US 2026/0321913 A1
(43) Pub. Date: Oct. 15, 2026

(54) ELECTRODE ASSEMBLY AND SECONDARY BATTERY INCLUDING THE ELECTRODE ASSEMBLY

(71) Applicant: SAMSUNG SDI CO., LTD., Yongin-si (KR)

(72) Inventors: Jun Sik KIM, Yongin-si (KR); Cheon Soo KIM, Yongin-si (KR)

(21) Appl. No.: 19/309,867

(22) Filed: Aug. 26, 2025

(30) Foreign Application Priority Data
Apr. 11, 2025 (KR) 10-2025-0047378

(51) Int. Cl. H01M 50/538; H01M 10/0587; H01M 50/46; H01M 50/533

(52) U.S. Cl. CPC H01M 50/538; H01M 10/0587; H01M 50/46; H01M 50/533

(57) ABSTRACT

An electrode assembly includes a first electrode plate, a plurality of first electrode tabs connected to the first electrode plate, a second electrode plate wound together with the first electrode plate about an axis that extends in a first direction, and a plurality of second electrode tabs connected to the second electrode plate. The plurality of first electrode tabs do not to overlap each other in a second direction that is perpendicular to the first direction.

### CROSS-REFERENCE TO THE RELATED APPLICATION

The present application claims priority to and the benefit of Korean Patent Application No. 10-2025-0047378, filed on Apr. 11, 2025, in the Korean Intellectual Property Office, the entire disclosure of which is incorporated herein by reference.

### BACKGROUND

### 1. Field

Embodiments relate to an electrode assembly and a secondary battery including the electrode assembly.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the disclosure and therefore it may contain information that does not constitute prior art.

### SUMMARY

Embodiments of the present disclosure provide an electrode assembly that is capable of preventing interference between electrode tabs by optimizing the arrangement and structure of the electrode tabs in the electrode assembly and capable of reducing the overall thickness and size of a battery by maximizing utilization of the internal space in the electrode assembly, and embodiments of the present disclosure provide a secondary battery including the electrode assembly.

Embodiments provide an electrode assembly that has a simplified connection structure between electrode tabs and electrode leads that improves structural stability and is applicable to various battery structures, and a secondary battery including the electrode assembly.

However, the technical problems to be achieved in the embodiment of the disclosure are not limited to the technical problems mentioned above, and other technical problems not mentioned herein will be clearly understood from the following description by those skilled in the art to which the disclosure belongs.

An electrode assembly according to an embodiment of the present disclosure includes a first electrode plate, a plurality of first electrode tabs connected to the first electrode plate, a second electrode plate wound together with the first electrode plate about an axis that extends in a first direction, and a plurality of second electrode tabs connected to the second electrode plate, wherein the plurality of first electrode tabs is mounted so as not to overlap each other in a second direction that is perpendicular to the first direction.

In some examples, the second electrode tabs do not to overlap each other in the second direction.

In some examples, the plurality of first electrode tabs may include a first inner tab connected to the first electrode plate and a first outer tab spaced apart from the first inner tab and connected to the first electrode plate.

In some examples, the plurality of second electrode tabs may include a second inner tab connected to the second electrode plate and a second outer tab spaced apart from the second inner tab and connected to the second electrode plate.

In some examples, the first inner tab and the second inner tab may be disposed at the start of the winding of the electrode assembly.

In some examples, the first outer tab and the second outer tab may be disposed at the end of the winding of the electrode assembly.

In some examples, the first inner tab and the second inner tab may be spaced apart from each other by a distance of D1, the first outer tab and the second outer tab may be spaced apart from each other by a distance of D2, and D1 may be less than D2.

In some examples, the first inner tab and the second inner tab may be spaced apart from each other by a distance of D1, the first outer tab and the second outer tab may be spaced apart from each other by a distance of D2, and D1 may be greater than D2.

In some examples, the first inner tab and the first outer tab may be spaced apart from each other by a distance of D3 in a third direction that is perpendicular to the first and second directions, the second inner tab and the second outer tab may be spaced apart from each other by a distance of D4 in the third direction, and D3 may be equal to D4.

In some examples, the electrode assembly may be formed by winding the first electrode plate, the second electrode plate, and a separator, and the electrode assembly may include an outer side including a flat surface as a planar region, and a rounded portion, formed as a curved region. The first electrode tabs and the second electrode tabs may be disposed at positions overlapping the flat surface in the vertical direction.

A secondary battery according to an embodiment of the present disclosure includes a case and an electrode assembly accommodated in the case, the electrode assembly being formed by winding a first electrode plate, a second electrode plate, and a separator about an axis that extends in a first direction, and the electrode assembly including a plurality of first electrode tabs mounted on the first electrode plate and a plurality of second electrode tabs mounted on the second electrode plate, wherein the first electrode tabs do not to overlap each other in a second direction that is perpendicular to the first direction, and the second electrode tabs do not to overlap each other in the second direction.

In some examples, the plurality of first electrode tabs may include a first inner tab connected to the first electrode plate and a first outer tab spaced apart from the first inner tab and connected to the first electrode plate, and the plurality of second electrode tabs may include a second inner tab connected to the second electrode plate and a second outer tab spaced apart from the second inner tab and connected to the second electrode plate.

In some examples, the secondary battery may further include a connector connected to the first inner tab and the first outer tab and a lead electrically connected to the first connector.

In some examples, one or more of the first inner tab and the first outer tab may be bent into an L-shape or a V-shape.

In some examples, the lead may be connected to a first side surface of the connector, and the first inner tab and the first outer tab may be connected to a second surface of the first connector that is opposite the first side surface.

In some examples, the lead, the first inner tab, and the first outer tab may be connected to one of a first side surface and a second side surface of the first connector.

In some examples, one or more of the second inner tab and the second outer tab may be bent into an L-shape or a V-shape.

In some examples, the secondary battery may further include a connector connected to the second inner tab and the second outer tab and a lead electrically connected to the second connector.

In some examples, the lead may be connected to a first side surface of the second connector, and the second inner tab and the second outer tab may be connected to a second side surface of the connector that is opposite the first side surface.

In some examples, the lead, the second inner tab, and the second outer tab may be connected to one of a first side surface and a second side surface of the connector.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings. In the drawings:

FIG. 1 is an exploded perspective view of a secondary battery according to an embodiment of the present disclosure;

FIG. 2 is a perspective view of the secondary battery according to an embodiment of the present disclosure;

FIG. 3 is a cross-sectional view of the secondary battery according to an embodiment of the present disclosure;

FIG. 4 is a cross-sectional view of an electrode assembly of the secondary battery according to an embodiment of the present disclosure;

FIG. 5 is a cross-sectional view showing a mounting state of second electrode tabs in the secondary battery according to an embodiment of the present disclosure;

FIG. 6 is a plan view showing a first electrode plate and a second electrode plate of the secondary battery according to an embodiment of the present disclosure;

FIG. 7 is a plan view showing arrangement of electrode tabs, connectors, and electrode leads according to an embodiment of the present disclosure;

FIG. 8 is a side cross-sectional view showing arrangement of the electrode tabs, the connectors, and the electrode leads according to an embodiment of the present disclosure;

FIG. 9 is a side cross-sectional view showing arrangement of the electrode tabs, the connectors, and the electrode leads according to an embodiment of the present disclosure;

FIG. 10 is a side cross-sectional view showing arrangement of the electrode tabs, the connectors, and the electrode leads according to an embodiment of the present disclosure;

FIG. 11 is a side cross-sectional view showing arrangement of the electrode tabs, the connectors, and the electrode leads according to an embodiment of the present disclosure;

FIG. 12 is a side cross-sectional view showing arrangement of the electrode tabs, the connectors, and the electrode leads according to an embodiment of the present disclosure;

FIG. 13 is a side cross-sectional view showing arrangement of the electrode tabs, the connectors, and the electrode leads according to an embodiment of the present disclosure;

FIG. 14 is a plan view showing arrangement of the electrode tabs, the connectors, and the electrode leads according to an embodiment of the present disclosure;

FIG. 15 is a plan view showing arrangement of the electrode tabs, the connectors, and the electrode leads according to an embodiment of the present disclosure;

FIG. 16 is a cross-sectional view of a secondary battery according to an embodiment of the present disclosure;

FIG. 17 is a cross-sectional view of a secondary battery according to an embodiment of the present disclosure;

FIGS. 18 and 19 are perspective views showing a battery pack including an exemplary secondary battery according to the present disclosure; and

FIGS. 20 and 21 are a perspective view and a side view showing a vehicle including an exemplary battery pack according to the present disclosure.

### DETAILED DESCRIPTION OF EXEMPLARY EMBODIMENTS

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the disclosure, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

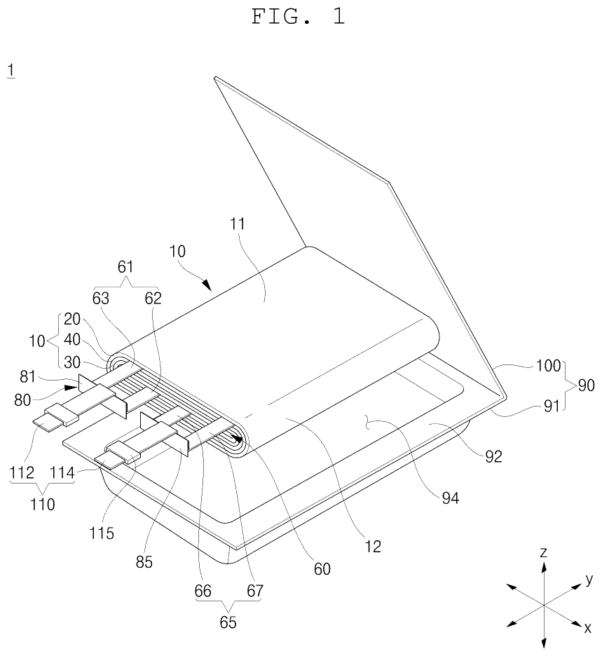

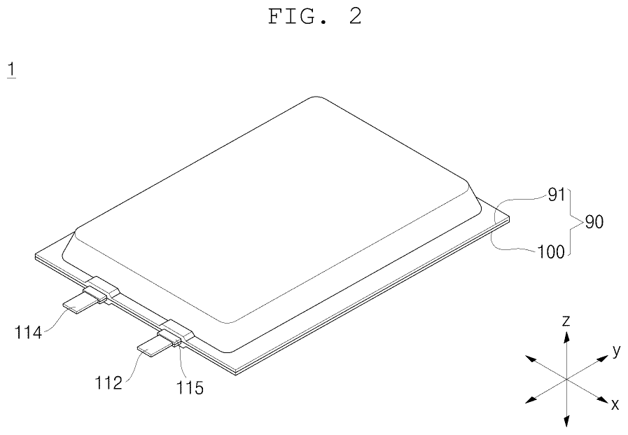

FIG. 1 is an exploded perspective view of a secondary battery 1 according to an embodiment of the present disclosure, and FIG. 2 is a perspective view of the secondary battery 1 according to the embodiment of the present disclosure. As shown in FIGS. 1 and 2, the secondary battery 1 may include an electrode assembly 10, electrode tabs 60, connectors 80, and electrode leads 110. In some examples, the secondary battery 1 may further include an insulating member 70 (see FIG. 3), a case 90, and an insulating fusion film 115.

The directions used in the present disclosure will be defined as follows and as shown in the figures. A longitudinal direction is defined as a y-direction, a width direction intersecting perpendicularly to the longitudinal direction y is defined as an x-direction, and a vertical direction intersecting perpendicularly to the longitudinal direction y and the width direction x is defined as a z-direction. The longitudinal direction y may be referred to as a first direction, the width direction x may be referred to as a third direction, and the vertical direction z may be referred to as a second direction.

The present disclosure relates to an electrode assembly 10 and a secondary battery 1 including the same. Interference between the electrode tabs 60 may be prevented by optimizing the arrangement and structure of the electrode tabs 60. The overall thicknesses and sizes of the electrode assembly 10 and the secondary battery 1 may be reduced by maximizing utilization of the internal space in the electrode assembly 10.

Referring again to FIGS. 1 and 2, the secondary battery 1 of the present disclosure may include an electrode assembly 10 including a first electrode plate 20, a second electrode plate 30, and a separator 40 that electrically insulates the first electrode plate 20 and the second electrode plate 30 from each other. The electrode assembly 10 may be formed in a wound roll shape. Each of the first electrode plate 20 and the second electrode plate 30 may be provided with a plurality of electrode tabs 60. The electrode tabs 60 may be disposed so as not to overlap each other in the vertical direction z. The electrode tabs 60 may be easily connected to the electrode leads 110 through the connectors 80 even while being spaced apart from each other in the horizontal direction. As a result, the assembly structure is simplified and the assembly structure can be manufacturing more efficiently.

The electrode tabs 60 may include inner tabs and outer tabs that are disposed at the winding start part and the winding end part of the electrode assembly 10, respectively. By optimizing a distance between the electrode tabs 60, interference between the electrode tabs 60 may be minimized, and the quality of the winding process and the structural reliability may be improved. The electrode tabs 60 may be bent in an L-shape or a V-shape to facilitate electrical connection to the electrode leads 110.

The electrode assembly 10 may be accommodated in the case 90, and the case 90 may be sealed to protect the electrode assembly 10 and to prevent leakage of electrolyte. An outer side of the electrode assembly 10 may include a flat surface 11 and a rounded portion 12, and the electrode tabs 60 may be disposed at positions overlapping the flat surface 11 in the vertical direction z.

The secondary battery 1 according to the present disclosure may maximize utilization of the internal space and ease the assembly process by optimizing the structure and arrangement of the electrode tabs 60. Further, as the overall thickness and size of the battery may be reduced, energy density may increase and the battery may be miniaturized and have reduced weight. Through these technical improvements, the secondary battery 1 according to the present disclosure is readily applicable to various battery structures.

The electrode assembly 10 may be formed by winding the first electrode plate 20, the second electrode plate 30, and the separator 40. The electrode assembly 10 may include a plurality of first electrode tabs 61 mounted on the first electrode plate 20 and a plurality of second electrode tabs 65 mounted on the second electrode plate 30. The electrode assembly 10 may be implemented as a wound type having a flat surface.

In embodiments of the present disclosure, the electrode assembly 10 is accommodated in the case 90. The case 90 may be referred to as a pouch. The electrode assembly 10 may have a structure in which the separator 40 is disposed between the first electrode plate 20 and the second electrode plate 30, and the electrode assembly 10 may be configured such that the electrode tabs 60 are formed in one direction.

The electrode assembly 10 may be accommodated in the case 90 together with electrolyte. The electrolyte may be composed of a combination of an organic solvent and a lithium salt. As the organic solvent, ethylene carbonate (EC), propylene carbonate (PC), diethyl carbonate (DEC), ethyl methyl carbonate (EMC), or dimethyl carbonate (DMC) may be used. As the lithium salt, LiPF₆ or LiBF₄ may be used. The electrolyte may be formulated in consideration of electrical and chemical reactivity with the electrodes.

The first electrode plate 20 may be a plate-shaped structure made of aluminum (Al). The first electrode plate 20 may function as a positive electrode plate and include a positive electrode active material, and a plurality of first electrode tabs 61 may be connected to the first electrode plate 20.

The second electrode plate 30 may be a plate-shaped structure made of copper (Cu) or nickel (Ni). The second electrode plate 30 may function as a negative electrode plate and include a negative electrode active material. The second electrode plate 30 may be wound together with the first electrode plate 20 about an axis extending in a first direction (e.g., the y-direction shown in FIG. 1) to form the electrode assembly 10. A plurality of second electrode tabs 65 may be connected to the second electrode plate 30.

The separator 40 may be disposed between the electrode plates to prevent an electrical short circuit and allow the migration of lithium ions. The separator 40 may be made of polyethylene (PE) or polypropylene (PP). However, the disclosure is not limited to these examples. The separator 40 may be implemented as various porous structures to ensure the efficiency and safety of electrochemical reaction.

The electrode tabs 60 may include first electrode tabs 61 and second electrode tabs 65. The electrode tabs 60 may be connected to the electrode plates to transfer current between the electrode assembly 10 and an external terminal, and the electrode tabs 60 may be electrically connected to the external terminal through the connectors 80 and the electrode leads 110. The electrode tabs 60 may be disposed in consideration of the structural stability of the battery and may be designed to prevent interference therebetween and to maximize utilization of the space in the wound electrode assembly 10.

A plurality of first electrode tabs 61 may be connected to the first electrode plate 20. As shown in FIG. 1, the plurality of first electrode tabs 61 may be spaced a predetermined distance from each other in the horizontal direction x so as not to overlap each other in the vertical direction z. This arrangement may prevent interference between the electrode tabs 60 during the winding process and may improve the quality of the electrode assembly 10. The first electrode tabs 61 may be connected to the electrode lead 110 by a first connector 81. The first electrode tabs 61 may be bent in an L-shape or a V-shape as needed to minimize interference with the internal structure of the battery.

A plurality of second electrode tabs 65 may be connected to the second electrode plate 30. As shown in FIG. 1, the plurality of second electrode tabs 65 may be spaced a predetermined distance from each other in the horizontal direction x so as not to overlap each other in the vertical direction z. The second electrode tabs 65 may be electrically connected to the electrode lead 110 by a second connector 85. Thus, the second electrode tabs 65 may be easily connected to the electrode lead 110 even while being spaced apart from each other in the horizontal direction. The second electrode tabs 65 may be bent in an L-shape or a V-shape to improve the efficiency of the assembly process and ensure structural stability.

The connectors 80 may electrically connect the plurality of electrode tabs 60 to the electrode leads 110. The connectors 80 may be formed in various structures and shapes. The connectors 80 may function to optimize the arrangement and structure of the electrode tabs 60 and to facilitate electrical connection to the electrode leads 110, thereby making the battery assembly process more efficient.

In an embodiment of the present disclosure, the connectors 80 may be rectangular plate shaped. The electrode tabs 60 may be connected to first surfaces of the connectors 80, and the electrode leads 110 may be electrically connected to second surfaces of the connectors 80. The shape of the connectors 80 according to the present disclosure is not limited to a rectangular shape, and may be modified into various other shapes, such as a triangular shape or an elliptical shape. The connectors 80 may include a first connector 81 electrically connected to the first electrode tabs 61 and a second connector 85 electrically connected to the second electrode tabs 65.

The first connector 81 may be connected to a first inner tab 62 and a first outer tab 63 among the first electrode tabs 61. The first connector 81 may be disposed such that the tabs are connected thereto while being spaced a predetermined distance from each other in the horizontal direction shown in FIG. 1.

The second connector 85 may be connected to a second inner tab 66 and a second outer tab 67 among the second electrode tabs 65. The second connector 85 may also be disposed to allow the tabs to be easily connected to the electrode lead 110 while being spaced a predetermined distance from each other in the horizontal direction shown in FIG. 1.

In some examples, the first connector 81 and the second connector 85 may be symmetric to each other, and connection portions of the connectors 80 may be fixed by welding, riveting, or electrical crimping. The connectors 80 may be formed of a material having electrical conductivity (e.g., aluminum, copper, or an alloy thereof) to minimize resistance to current flow.

The case 90 may accommodate the electrode assembly 10 and may be sealed in a state in which the electrode leads 110 are drawn to outside of the case 90. The case 90 may be formed in various shapes to surround the outer side of the electrode assembly 10. In an embodiment of the present disclosure, the case 90 is a pouch formed from a flexible film. In such an embodiment, a rectangular film extending in the first direction y may be folded to form a case main body 91 and a case cover 100.

After the electrode assembly 10 is accommodated in a recess 94 formed in the case main body 91, the case cover 100 may be rotated to cover the opening in the case main body 91. In the present disclosure, the pouch is not limited to an integrated structure in which the case main body 91 and the case cover 100 are formed on a single film. However, for convenience, an example in which the case main body 91 and the case cover 100 are formed on a single rectangular film will be described below.

The case main body 91 may include a recess 94 and a sealing portion 92. The recess 94 in which the electrode assembly 10 is accommodated may be formed at a substantially central portion of the case main body 91, and the sealing portion 92 may extend substantially outward from three sides of the recess 94.

The sealing portion 92 may be a surface that is parallel to and bonded to the case cover 100. For example, if the case main body 91 and the case cover 100 are provided as separate members, the sealing portion 92 may extend outward from four sides of the recess 94. Even when the case main body 91 and the case cover 100 are integrally formed, the sealing portion 92 may also extend outward from four sides of the recess 94.

Each of the case cover 100 and the case main body 91 may be formed as a multilayer thin film that includes a metal thin film and insulating layers formed on one surface and the opposite surface of the metal thin film. The case cover 100 may include an inner surface that contacts the case main body 91 and an outer surface that is opposite the inner surface. Similarly, the case main body 91 may include an inner surface that contacts the case cover 100 and an outer surface that is opposite the inner surface.

The recess 94 in the case main body 91 may be sized to accommodate the electrode assembly 10 through a pressing or drawing process. After the portion of the case main body 91 in which the recess 94 is formed is covered by the case cover 100, an edge of the recess 94 and an edge of the case cover 100 may be thermally fused to each other. That is, the pouch may be sealed by thermally bonding an edge region of the case main body 91 and an edge region of the case cover 100 after the electrode assembly 10 is accommodated in the recess 94.

Herein, the edge of the case main body 91 that is located outside the recess 94 in a plan view and is sealed to the edge of the case cover 100 is referred to as a sealing portion 92. A heat-sealing layer formed of a heat-fusible material may be formed on the inner surface of the pouch.

The case cover 100 may be rectangular flat plate shaped. The case cover 100 may be connected to the case main body 91 and may cover an upper portion of the case main body 91 by a folding operation.

The electrode leads 110 may connect the electrode tabs 60, which are electrically connected to the electrode assembly 10, to an external circuit or terminal to allow for current flow. A first side of the electrode lead 110 may be electrically connected to the electrode tabs 60 of the electrode assembly 10, and a second side of the electrode lead 110 may extend to outside of the case 90 and be electrically connected to an external terminal.

In an embodiment of the present disclosure, the electrode leads 110 may include a first lead 112 connected to the first electrode tabs 61 and a second lead 114 connected to the second electrode tabs 65. Each of the first lead 112 and the second lead 114 may be connected to a corresponding one of the connectors 80. Such an arrangement enables stable electrical connection even when the electrode tabs 60 are spaced apart from each other in the horizontal or vertical direction.

The electrode leads 110 may be formed of a metallic material having high electrical conductivity and low internal resistance (e.g., aluminum, copper, or an alloy thereof). A multilayer structure or plating treatment may be applied to the electrode leads 110 to enhance mechanical strength and durability.

The electrode leads 110 may be bendable to facilitate connection to the connectors 80. The electrode leads 110 may be formed in an I-shape, an L-shape, a V-shape, or other shapes depending on the structure of the battery. This structural flexibility may contribute to maximizing utilization of the space in the case 90 and minimizing electrical interference.

The first lead 112 may be electrically connected to the first connector 81. The second lead 114 may be electrically connected to the second connector 85.

The insulating fusion film 115 may provide electrical insulation between the electrode leads 110 and the case 90. The insulating fusion film 115 may be mounted on outer sides of the electrode leads 110. The insulating fusion film 115 may be formed of a material having excellent flexibility and durability (e.g., polyethylene (PE), polyimide (PI), or polypropylene (PP)).

The insulating fusion film 115 may block electrical connection between the electrode leads 110 and the case 90, thereby making the battery safer and preventing short circuits caused by external electrical interference. In some examples, it is possible to improve the sealing of the case 90 by optimizing the thickness or arrangement structure of the insulating fusion film 115.

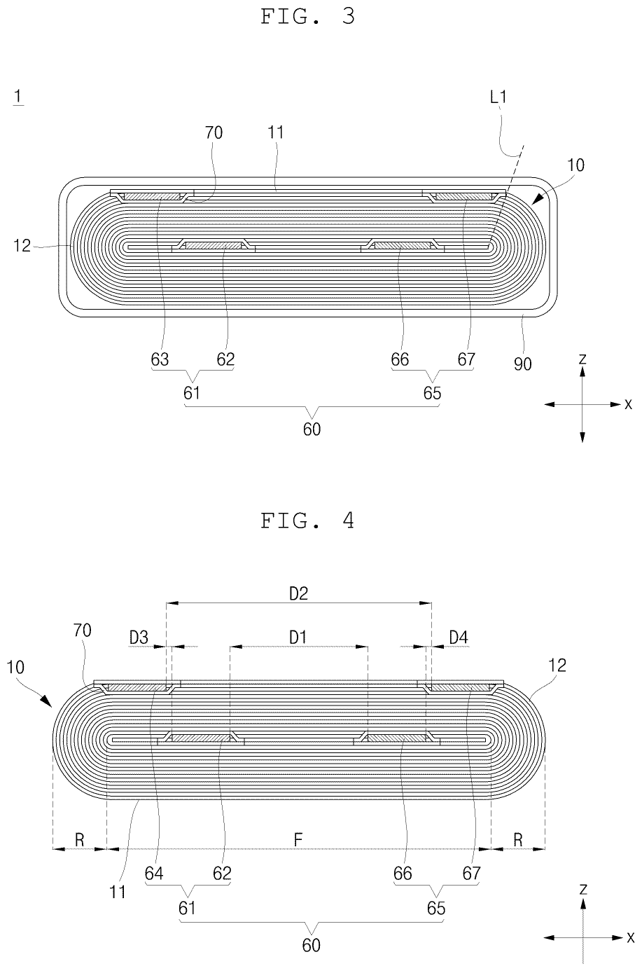

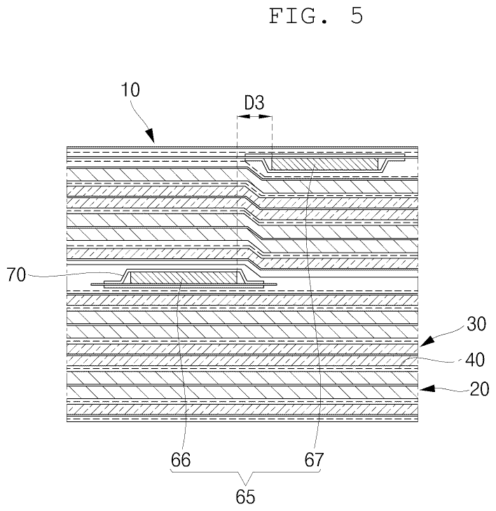

FIG. 3 is a cross-sectional view of the secondary battery 1 according to an embodiment of the present disclosure, FIG. 4 is a cross-sectional view of the electrode assembly 10 of the secondary battery 1 according to an embodiment of the present disclosure, and FIG. 5 is a cross-sectional view showing a mounting state of the second electrode tabs 65 in the secondary battery 1 according to an embodiment of the present disclosure. As shown in FIGS. 3 to 5, the electrode assembly 10 may include a flat surface 11 and a rounded portion 12 on an outer side, and the electrode tabs 60 may be disposed at positions overlapping the flat surface 11 in the vertical direction z.

The outer side of the electrode assembly 10 may include a flat surface 11 formed as a planar region and a rounded portion 12 formed as a curved region. The flat surface 11 may be a region in which a portion of the electrode assembly 10 extends linearly, and the rounded portion 12 may be a curved region formed during the process of winding the electrode assembly 10. The electrode tabs 60 may be disposed so as not to overlap each other in the vertical direction z, thereby preventing interference between the electrode tabs 60 and enhancing the structural stability of the electrode assembly 10.

The electrode tabs 60 may include first electrode tabs 61 and second electrode tabs 65, which are connected to the first electrode plate 20 and the second electrode plate 30, respectively, to transfer current. The electrode tabs 60 may be divided into inner tabs and outer tabs depending on the wound structure of the electrode assembly 10. The inner tabs and the outer tabs may be disposed at positions at a start of the winding and positions at an end part of the winding of the electrode assembly 10, respectively.

The first electrode tabs 61 may be connected to the first electrode plate 20, and the first electrode tabs 61 may include a first inner tab 62 and a first outer tab 63. The first inner tab 62 may be disposed at the start of the winding of the first electrode plate 20 so as to be in close contact with the internal structure of the electrode assembly 10. Because the first inner tab 62 is mounted at an initial stage of the winding, the first inner tab 62 may be stably secured at the center portion of the electrode assembly 10.

The first outer tab 63 may be disposed at the end part of the winding of the first electrode plate 20 so as to be connected to an outer structure of the electrode assembly 10. The first outer tab 63 may be formed at a stage in which the winding process of the electrode assembly 10 is completed, and the first outer tab 63 may be easily connected to the electrode lead 110.

The second electrode tabs 65 may be connected to the second electrode plate 30, and the second electrode tabs 65 may include a second inner tab 66 and a second outer tab 67. The second inner tab 66 may be disposed at the start of the winding of the second electrode plate 30 and may be secured inside the electrode assembly 10. The second inner tab 66 may be disposed at the central portion of the electrode assembly 10 so as to stably transfer current.

The second outer tab 67 may be disposed at the end part of the winding of the second electrode plate 30 so as to be easily connected to the electrode lead 110. The second outer tab 67 may be disposed in a horizontal direction or in a bent form, thereby improving space utilization and minimizing structural interference.

The first inner tab 62 and the second inner tab 66 disposed at the start of the winding of the electrode assembly 10 may be spaced apart from each other. The first outer tab 63 and the second outer tab 67 disposed at the end of the winding of the electrode assembly 10 may be spaced apart from each other.

The insulating members 70 may surround outer sides of the electrode tabs 60 to provide electrical insulation. The insulating members 70 may prevent electrical interference inside the electrode assembly 10 and enhance its structural reliability. each of the insulating members 70 may cover the outer side of one of the first inner tab 62, the first outer tab 63, the second inner tab 66, and the second outer tab 67.

The insulating member 70 may be formed of a material having excellent flexibility and durability, such as polyethylene terephthalate (PET), polyethylene (PE), polypropylene (PP), polyimide (PI), or a combination thereof.

The insulating members 70 may partially or entirely surround the tabs depending on the wound structure of the electrode assembly 10. The insulating members 70 may be formed as multilayer structures to maximize insulation performance. In some examples, the insulating members 70 may be bent or cut form to conform to the shape of the electrode tabs 60, thereby improving utilization of the space in the electrode assembly 10. Thus, the insulating members 70 may effectively provide electrical insulation between the electrode tabs 60 and surrounding structures.

In some embodiments, a distance D1 between the first inner tab 62 and the second inner tab 66 may be less than a distance D2 between the first outer tab 63 and the second outer tab 67 (D1<D2). As discussed above, the first inner tab 62 and the second inner tab 66 may be disposed at the start of the winding of the electrode assembly 10, and the first outer tab 63 and the second outer tab 67 may be disposed at the end of the winding of the electrode assembly 10. The first inner tab 62 and the second inner tab 66 may be disposed relatively close to the center of the electrode assembly 10, and the first outer tab 63 and the second outer tab 67 may be disposed relatively far from the center of the electrode assembly 10. With this arrangement of the electrode tabs 60, the electrode tabs 60 may not overlap each other in the vertical direction z. As a result, the electrode assembly 10 may have a reduced thickness compared to a configuration in which the electrode tabs 60 overlap each other in the vertical direction z.

In some examples, a distance D3 between the first inner tab 62 and the first outer tab 63 in the horizontal direction may be equal to a distance D4 between the second inner tab 66 and the second outer tab 67 in the horizontal direction (D3=D4). Uniform distances between the tabs may contribute to maintaining the structural balance of the electrode assembly 10 and optimizing current transfer paths, thereby enhancing the performance and reliability of the battery.

A threshold line L1 may extend from the start of the winding of the electrode assembly 10 to a boundary between the flat surface 11 and the rounded portion 12, and the threshold line L1 may be a limit within which the first outer tab 63 or the second outer tab 67 is disposed. A configuration in which the first inner tab 62 and the second inner tab 66 are disposed relatively close to the start of the winding of the electrode assembly 10 and the first outer tab 63 and the second outer tab 67 are disposed relatively far from the start of the winding, that is, relatively close to the end of the winding of the electrode assembly 10, may minimize interference between the electrode tabs 60. Thus, the configuration enables more efficient winding of the electrode assembly 10. Further, such a structural configuration may contribute to maintaining balance between the electrode tabs 60 and ensuring the stability of the tabs disposed adjacent to the rounded portion 12. As a result, the space for arrangement of the electrode tabs 60 may be optimized, the structural reliability of the electrode assembly 10 may be improved, and the quality of the manufacturing process of the secondary battery may be improved.

The overall length of the electrode assembly 10 in the horizontal direction may include the length F of the flat surface 11 and the length R of the rounded portion 12. As such, the overall length of the electrode assembly 10 in the horizontal direction may be expressed as F+2R.

The horizontal length F of the flat surface 11 may be greater than the distance D2 between the first outer tab 63 and the second outer tab 67 (F>D2). With the configuration such that the horizontal length F of the flat surface 11 is greater than D2, sufficient space for arrangement of the electrode tabs 60 may be provided, thereby preventing interference between the tabs and facilitating the structural design of the rounded portion 12. Further, such a length may enable stable placement of the electrode tabs 60 during the winding process of the electrode assembly 10 and may contribute to preventing mechanical damage that may occur due to contact between the electrode tabs 60 and the rounded portion 12.

FIG. 6 is a plan view showing the first electrode plate 20 and the second electrode plate 30 of the secondary battery 1 according to an embodiment of the present disclosure. As shown in FIG. 6, the first electrode plate 20 may include a positive electrode coated portion 22 and positive electrode uncoated portions 24.

A positive electrode active material including a transition metal oxide may be coated on at least one surface of the first electrode plate 20 to form the positive electrode coated portion 22. The positive electrode uncoated portions 24, where the positive electrode active material is not provided, are formed at opposite sides of the first electrode plate 20. The positive electrode uncoated portions 24 be regions to which the electrode tabs 60 are mounted.

The first electrode tabs 61 may be mounted based on a centerline 26 of the positive electrode uncoated portion that extends in the vertical direction z from the center of the positive electrode uncoated portion 24 in the width direction x. A first side of the first electrode plate 20 in the width direction x (the left side in FIG. 6) may be defined as a leading end, and a second side of the first electrode plate 20 in the width direction x (the right side in FIG. 6) may be defined as a trailing end. The positive electrode uncoated portions 24 may be disposed at the leading and trailing ends of the first electrode plate 20, and the positive electrode coated portion 22 may be formed between the positive electrode uncoated portions 24.

In some examples, the first inner tab 62 may be connected to the positive electrode uncoated portion 24 disposed at the leading end of the first electrode plate 20. The first inner tab 62 may be spaced apart from the centerline 26 of the positive electrode uncoated portion and may be mounted at a position in the positive electrode uncoated portion 24 that is adjacent to the leading end of the first electrode plate 20. This arrangement provides a configuration in which the first inner tab 62 is disposed at the start of the winding of the electrode assembly 10.

In some examples, the first outer tab 63 may be connected to the positive electrode uncoated portion 24 disposed at the trailing end of the first electrode plate 20. The first outer tab 63 may be spaced apart from the centerline 26 of the positive electrode uncoated portion and may be mounted at a position in the positive electrode uncoated portion 24 that is adjacent to the positive electrode coated portion 22. The first outer tab 63 may be disposed at the end of the winding of the electrode assembly 10, thereby enabling balanced winding.

The second electrode plate 30 may include a negative electrode coated portion 32 and negative electrode uncoated portions 34.

A negative electrode active material, such as a graphite-based active material or silicon-based active material, may be coated on at least one surface of the second electrode plate 30 to form the negative electrode coated portion 32. The negative electrode coated portion 32 may provide a region in which electrochemical reaction is performed.

The negative electrode uncoated portions 34, which are not coated with the negative electrode active material, may be provided on both sides of the second electrode plate 30. The negative electrode uncoated portions 34 may be regions where the electrode tabs 60 are mounted.

The second electrode tabs 65 may be mounted based on a centerline 36 of the negative electrode uncoated portion that extends in the vertical direction z from the center of the negative electrode uncoated portion 34 in the width direction x. A first side of the second electrode plate 30 in the width direction x (the left side in FIG. 6) may be defined as a leading end, and a second side of the second electrode plate 30 in the width direction x (the right side in FIG. 6) may be defined as a trailing end. The negative electrode uncoated portions 34 may be y disposed at the leading end and the trailing end of the second electrode plate 30, and the negative electrode coated portion 32 may be formed between the negative electrode uncoated portions 34.

In some examples, the second inner tab 66 may be connected to the negative electrode uncoated portion 34 disposed at the leading end of the second electrode plate 30. The second inner tab 66 may be spaced apart from the centerline 36 of the negative electrode uncoated portion and may be mounted at a position in the negative electrode uncoated portion 34 that is adjacent to the leading end of the second electrode plate 30. This configuration provides for a structure in which the second inner tab 66 is disposed at the start of the winding of the electrode assembly 10.

In some examples, the second outer tab 67 may be connected to the negative electrode uncoated portion 34 disposed at the trailing end of the second electrode plate 30. The second outer tab 67 may be spaced apart from the centerline 36 of the negative electrode uncoated portion and may be mounted at a position in the negative electrode uncoated portion 34 that is adjacent to the negative electrode coated portion 32. The second outer tab 67 may be disposed at the end of the winding of the electrode assembly 10, thereby enabling balanced winding.

In an embodiment of the present disclosure, the length and height of the negative electrode coated portion 32 may be set to be greater than the length and height of the positive electrode coated portion 22, thereby providing a structure in which the negative electrode coated portion 32 surrounds the positive electrode coated portion 22. This structure may be advantageous in ensuring stable winding of the electrode assembly 10 and uniformity in electrochemical reaction.

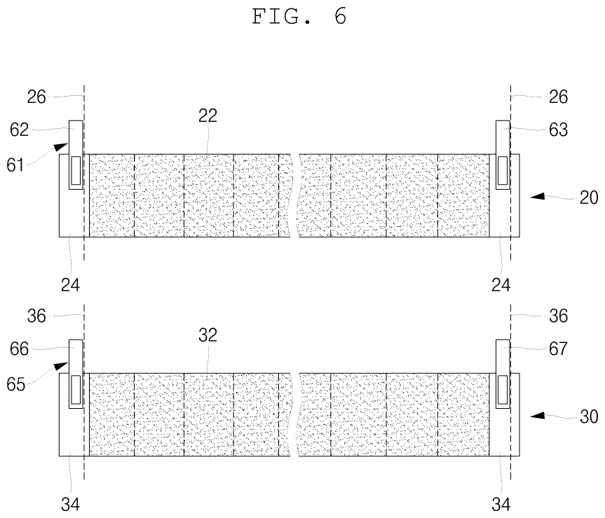

FIG. 7 is a plan view showing arrangement of the electrode tabs 60, the connectors 80, and the electrode leads 110 according to an embodiment of the present disclosure, and FIG. 8 is a side cross-sectional view showing arrangement of the electrode tabs 60, the connectors 80, and the electrode leads 110 according to an embodiment of the present disclosure. As shown in FIGS. 7 and 8, the first inner tab 62 and the first outer tab 63 may be bent in an L-shape or a V-shape. The second inner tab 66 and the second outer tab 67 may also be bent in an L-shape or a V-shape.

The first connector 81 may be connected to the first inner tab 62 and the first outer tab 63, and the first lead 112 may be electrically connected to the first connector 81. The first connector 81 may be formed in a rectangular plate shape. A surface of the first connector 81 that faces the electrode assembly 10 may be defined as a first side surface 82, and a surface of the first connector 81 that is opposite the first-first side surface 82 may be defined as a first-second side surface 83.

The first inner tab 62 and the first outer tab 63 may be bent into V-shapes to be fixed to the first-second side surface 83 of the first connector 81. The first lead 112 may be bent in an L-shape to be fixed to the first-first side surface 82 of the first connector 81. This configuration allows the first inner tab 62 and the first outer tab 63 to be stably joined to the first connector 81 and may facilitate electrical connection of the first lead 112 to an external terminal. As such, the first inner tab 62 and the first outer tab 63 may be mounted to face the first lead 112, with the first connector 81 disposed therebetween.

The second connector 85 may be connected to the second inner tab 66 and the second outer tab 67, and the second lead 114 may be electrically connected to the second connector 85. The second connector 85 may be formed in a rectangular plate shape. A surface of the second connector 85 that faces the electrode assembly 10 may be defined as a second-first side surface 86, and a surface of the second connector 85 that is opposite the second side surface 86 may be defined as a second-second surface 87.

The second inner tab 66 and the second outer tab 67 may be bent into V-shapes to be fixed to the second-second surface 87 of the second connector 85. The second lead 114 may be bent in an L-shape to be fixed to the second-first side surface 86 of the second connector 85. This structure may ensure stable maintenance of electrical connection of the second inner tab 66 and the second outer tab 67 and may facilitate connection of the second lead 114 to an external terminal.

As described above, the first connector 81 and the second connector 85 may provide an efficient electrical connection structure that optimizes the arrangement of the electrode tabs 60 and the electrode leads 110 and prevents interference between the inner tabs and the outer tabs disposed at the winding start part and the winding end part of the electrode assembly 10. With such a configuration, the electrical performance of the electrode assembly 10 may be improved, and the battery assembly process may be simplified.

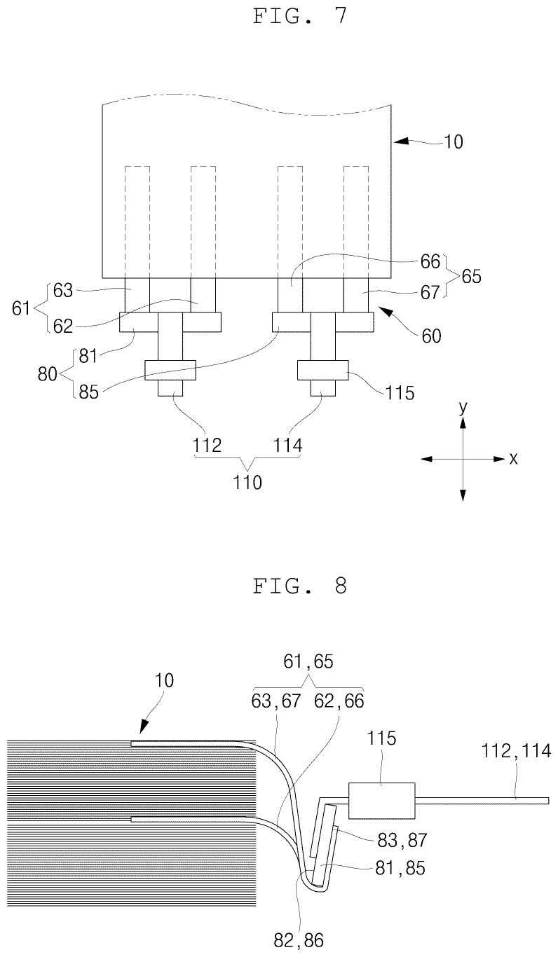

FIG. 9 is a side cross-sectional view showing arrangement of the electrode tabs 60, the connectors 80, and the electrode leads 110 according to another embodiment of the present disclosure. As shown in FIG. 9, the first outer tab 63 may be disposed above the first inner tab 62.

In this embodiment, the first connector 81 has an increased size relative to the above-described embodiments. As such, different components may be connected to the upper side and the lower side of the first connector 81. For example, the first lead 112 may be connected to the upper side of the first side surface 82 of the first connector 81, and the first inner tab 62 and the first outer tab 63 may be connected to the lower side of the first opposite surface 83 of the first connector 81.

In this embodiment, the first inner tab 62 and the first outer tab 63 may be disposed so as not to face the first lead 112, but with the first connector 81 disposed between the tabs 62 and 63 and lead 112. This configuration enables efficient use of the areas of the upper and lower sides of the first connector 81, prevents of interference between the electrode tabs 60 and the electrode leads 110, and implements a stable electrical connection.

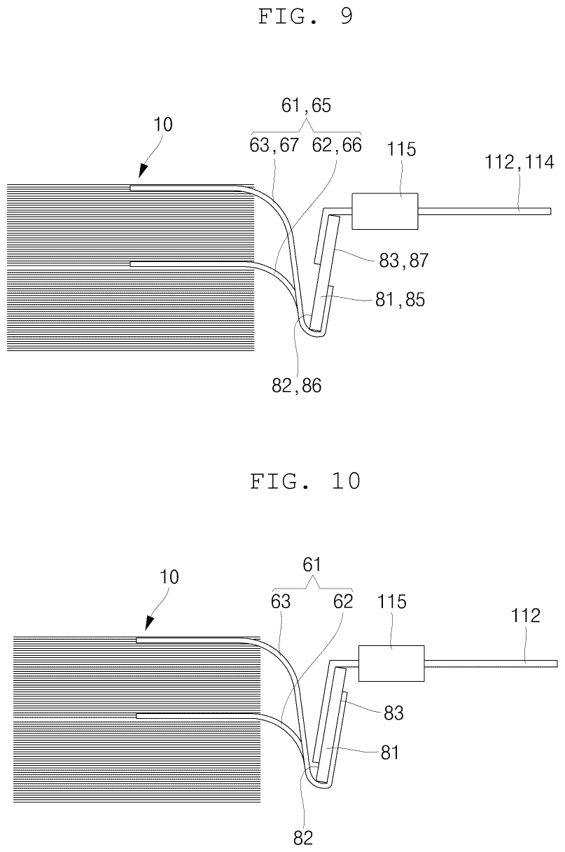

FIG. 10 is a side cross-sectional view showing arrangement of the electrode tabs 60, the connectors 80, and the electrode leads 110 according to still another embodiment of the present disclosure. As shown in FIG. 10, the first lead 112, the first inner tab 62, and the first outer tab 63 may be connected to the first connector 81. In this embodiment, the first lead 112, the first inner tab 62, and the first outer tab 63 may be extend relative to the above-described embodiments.

Most of the first side surface 82 of the first connector 81 may be covered by the first lead 112, and most of the second side surface 83 of the first connector 81 may be covered by the first inner tab 62 and the first outer tab 63. In this embodiment, the first inner tab 62 and the first outer tab 63 are bent into V-shapes and connected to the second side surface 83 of the first connector 81. The first lead 112 is bent in an L-shape and connected to the first side surface 82 of the first connector 81.

The first outer tab 63 may be disposed above the first inner tab 62. This configuration may prevent interference between the tabs, ensure a stable electrical connection, and maximizing space utilization.

FIG. 11 is a side cross-sectional view showing arrangement of the electrode tabs 60, the connectors 80, and the electrode leads 110 according to still another embodiment of the present disclosure. As shown in FIG. 11, the first lead 112, the first inner tab 62, and the first outer tab 63 may be connected to any one of the side surfaces 82 and 83 of the first connector 81. Although not shown in FIG. 11, the second lead, the second inner tab, and the second outer tab may be connected to any one of the side surfaces of the second connector.

The first lead 112, the first inner tab 62, and the first outer tab 63 may be connected to the first side surface 83 of the first connector 81. The first inner tab 62 and the first outer tab 63 are bent into V-shapes and connected to the lower side of the second surface 83 of the first connector 81. The first lead 112 is in an L-shape and connected to the upper side of the second side surface 83 of the first connector 81.

The second lead, the second inner tab, and the second outer tab may be connected to the second side surface of the second connector. The second inner tab and the second outer tab may be bent into V-shapes and connected to the lower side of the second side surface of the second connector 85. The second lead 114 may be bent in an L-shape to be connected to the upper side of the second side surface 87 of the second connector 85.

The first connector 81 and the second connector may be mounted in an upright orientation in the vertical direction z or may be mounted in an inclined orientation.

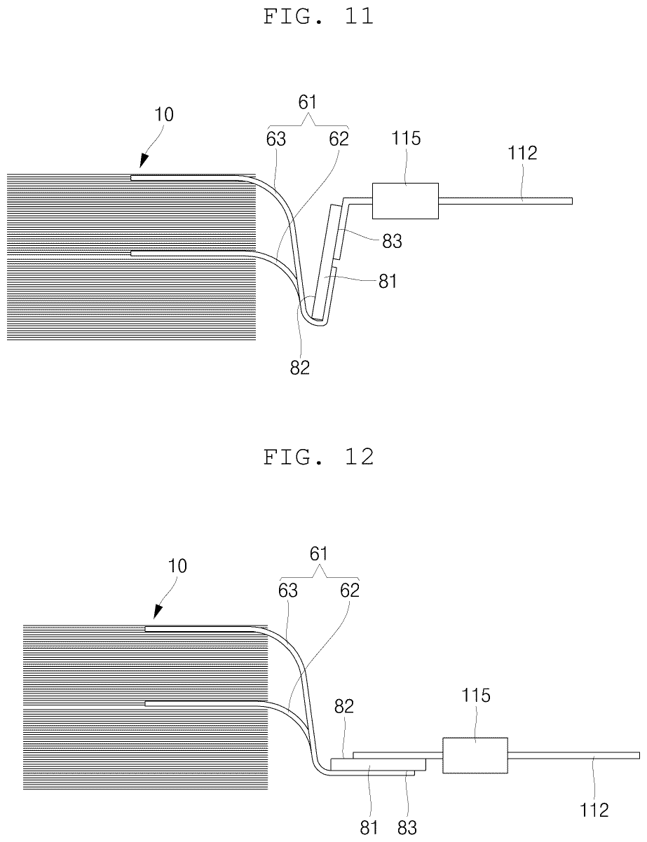

FIG. 12 is a side cross-sectional view showing arrangement of the electrode tabs 60, the connectors 80, and the electrode leads 110 according to still another embodiment of the present disclosure. As shown in FIG. 12, the first connector 81 may be mounted in a horizontal orientation. The first lead 112 may extend in the horizontal direction and may be connected to the first side surface 82 of the first connector 81, which is the upper surface of the first connector 81.

The first inner tab 62 and the first outer tab 63 may be connected to the second side surface 83 of the first connector 81, which is the lower surface of the first connector 81. The first inner tab 62 and the first outer tab 63 are bent into L-shapes and fixed to the second side surface 83. This configuration may enable more efficient arrangement of the electrode tabs 60 and the connectors 80 and may facilitate connection to the electrode leads 110.

A configuration in which the first connector 81 is mounted in a horizontal orientation may help to minimize the space required for mounting of the electrode leads 110 extending to the outside of the electrode assembly 10 and maintain reliability of electrical connection. Because the first inner tab 62 and the first outer tab 63 are disposed in an L-shaped configuration on the second surface 83 of the first connector 81, structural stability of the wound electrode assembly 10 may be secured.

Further, because the first connector 81 and the first lead 112 extend in the horizontal direction, it is possible to reduce the height of the battery and to maximize utilization of the internal space in the electrode assembly 10. This configuration may be advantageously applied to various battery applications requiring compact size and reduced weight.

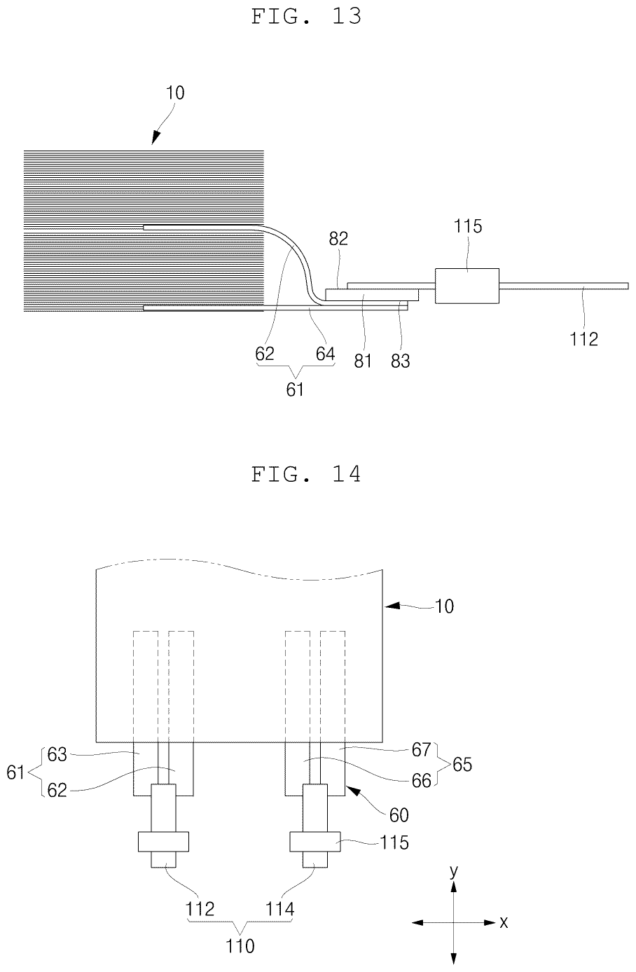

FIG. 13 is a side cross-sectional view showing arrangement of the electrode tabs 60, the connectors 80, and the electrode leads 110 according to still another embodiment of the present disclosure. As shown in FIG. 13, the first outer tab 64 may be disposed below the first inner tab 62. The first outer tab 64 may extend in the horizontal direction without being bent, while the first inner tab 62 may be bent downward.

The first connector 81 may be mounted in a horizontal orientation. The first lead 112 may extend in the horizontal direction and may be connected to the first side surface 82 of the first connector 81, which is the upper surface of the first connector 81. The first inner tab 62 and the first outer tab 64 may be connected to the second side surface 83 of the first connector 81, which is the lower surface of the first connector 81. The first inner tab 62 may be bent into an L-shape to be fixed to the second side surface 83, and the first outer tab 64 extending in the horizontal direction may also be fixed to the second side surface 83.

This configuration may enable optimization of arrangement of the tabs of the electrode assembly 10 by making the positions and shapes of the first inner tab 62 and the first outer tab 64 different from each other. Furthermore, because the first outer tab 64 extends in the horizontal direction without being bent, interference between the electrode tabs 60 may be minimized, and the structural stability of the electrode assembly 10 during the winding process may be ensured. Further, because the first connector 81 is mounted in a horizontal orientation, the extension direction of the electrode leads 110 may be simplified, and the height and volume of the battery may be reduced. This arrangement may contribute to enhancing coupling strength between the electrode tabs 60 and the connectors 80 and improves reliability of electrical connection.

FIG. 14 is a plan view showing arrangement of the electrode tabs 60, the connectors 80, and the electrode leads 110 according to still another embodiment of the present disclosure. As shown in FIG. 14, the first electrode tabs 61 may be directly connected to the first lead 112 without using a separate connector. For example, the first inner tab 62 and the first outer tab 63 may be directly connected to the first lead 112. The second electrode tabs 65 may also be directly connected to the second lead 114. For example, the second inner tab 66 and the second outer tab 67 may be directly connected to the second lead 114.

Because the connectors 80 are omitted in this embodiment, electrical connection paths may be simplified, and contact resistance between the electrode tabs 60 and the electrode leads 110 may be minimized. Further, reducing in the number of components may simplify the manufacturing process and may reduce the volume and manufacturing cost of the battery. Still further, because the electrode tabs 60 are directly connected to the electrode leads 110, electrical reliability may be improved, and the electrode tabs 60 and the electrode leads 110 may be disposed in a more structurally stable manner.

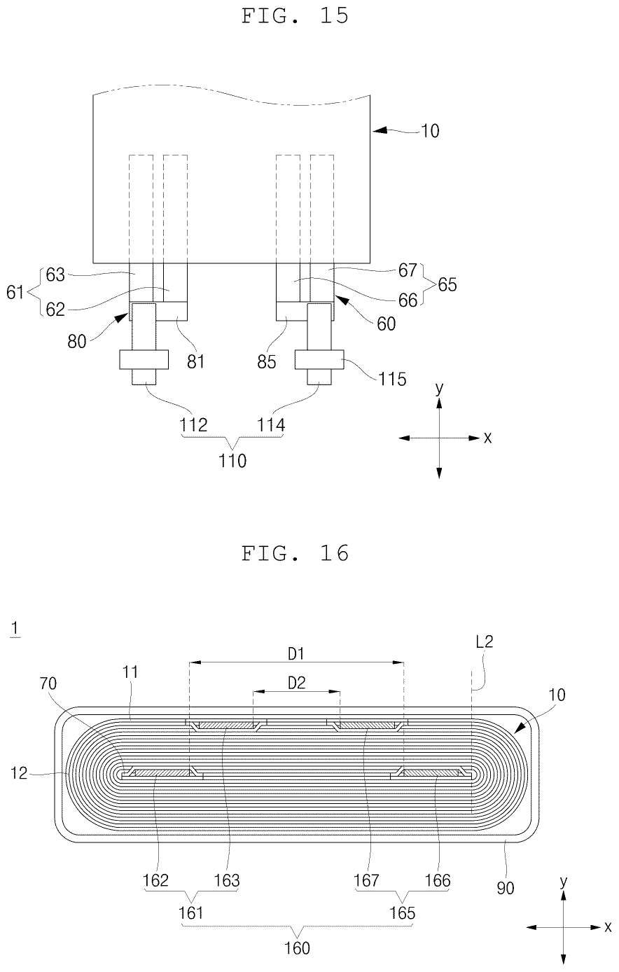

FIG. 15 is a plan view showing arrangement of the electrode tabs 60, the connectors 80, and the electrode leads 110 according to still another embodiment of the present disclosure. As shown in FIG. 15, the connectors 80 may be connected to the electrode tabs 60, and the electrode leads 110 may be connected to sides of the connectors 80.

In more detail, the first inner tab 62 and the first outer tab 63 may be connected to the first connector 81. The first lead 112 may be connected to one side of the first connector 81 in the width direction x. The first inner tab 62 and the first outer tab 63 may be fixed to different regions of the first connector 81 and may be configured with consideration of the efficiency of current paths.

The second inner tab 66 and the second outer tab 67 may be connected to the second connector 85. The second lead 114 may be connected to the opposite side of the second connector 85 in the width direction x. The second inner tab 66 and the second outer tab 67 may be fixed to different regions of the second connector 85, and the spatial arrangement may be optimized to prevent interference between the tabs.

The connectors 80 may be formed in a rectangular plate shape, and the surfaces of the connectors 80 to which the electrode leads 110 and the electrode tabs 60 are connected may be disposed in the horizontal direction or the vertical direction. This structure of the connectors 80 may stabilize electrical connection between the electrode leads 110 and the electrode tabs 60, and may minimize resistance to current flow.

The connectors 80 may be formed of a highly conductive metal (e.g., aluminum, copper, or an alloy thereof) and may be fixed to the electrode tabs 60 and the electrode leads 110 by riveting, welding, or electrical crimping as needed.

With such a configuration, the structure in this embodiment may enable efficient and reliable connection between the electrode tabs 60 and the electrode leads 110 and efficient utilization of the internal space in the electrode assembly 10, thereby contributing to miniaturization and weight reduction of the secondary battery 1.

FIG. 16 is a cross-sectional view of a secondary battery 1 according to another embodiment of the present disclosure. As shown in FIG. 16, electrode tabs 160 of the secondary battery 1 may include first electrode tabs 161 and second electrode tabs 165.

The first electrode tabs 161 may include a first inner tab 162 disposed at the start of the winding of the electrode assembly 10 and a first outer tab 163 disposed at the end of the winding of the electrode assembly 10. The second electrode tabs 165 may include a second inner tab 166 disposed at the start of the winding of the electrode assembly 10 and a second outer tab 167 disposed at the end of the winding of the electrode assembly 10.

A distance D1 between the first inner tab 162 and the second inner tab 166 may be greater than a distance D2 between the first outer tab 163 and the second outer tab 167 (D1>D2). This configuration may prevent interference between the electrode tabs 160 and may maximize utilization of the internal space in the electrode assembly 10.

A threshold line L2 extending vertically upward from an end of the winding, at which the first inner tab 162 or the second inner tab 166 is disposed, and which is adjacent to the rounded portion 12 of the electrode assembly 10, may pass through a boundary between the rounded portion 12 and the flat surface 11 of the electrode assembly 10. With such a configuration, the electrode tabs 160 may be disposed close to the rounded portion 12 while maintaining structurally stable connection.

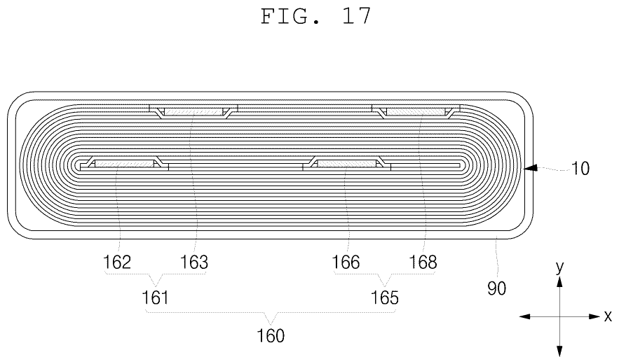

FIG. 17 is a cross-sectional view of a secondary battery 1 according to still another embodiment of the present disclosure. As shown in FIG. 17, the second outer tab 168, which is disposed above the second inner tab 166, may be mounted in a direction toward the rounded portion 12 rather than toward the first outer tab 163. The distance between the first inner tab 162 and the second inner tab 166 may be equal to the distance between the first outer tab 163 and the second outer tab 168.

The electrode assembly 10 of the present disclosure will now be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn₁₋gGgPO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (<×<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt% to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

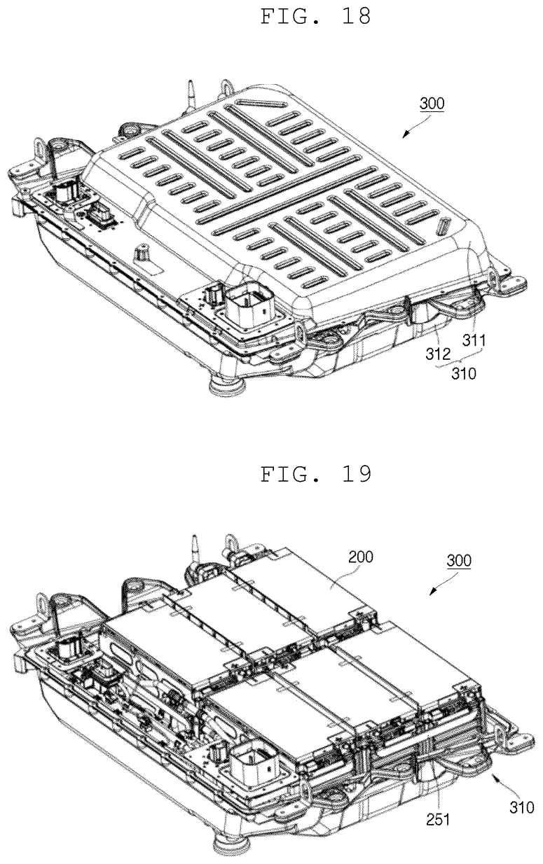

The batteries according to the above-described embodiments may be used to manufacture a battery pack. FIGS. 18 and 19 are perspective views showing a battery pack including the exemplary secondary battery according to the present disclosure. Referring to FIGS. 18 and 19, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

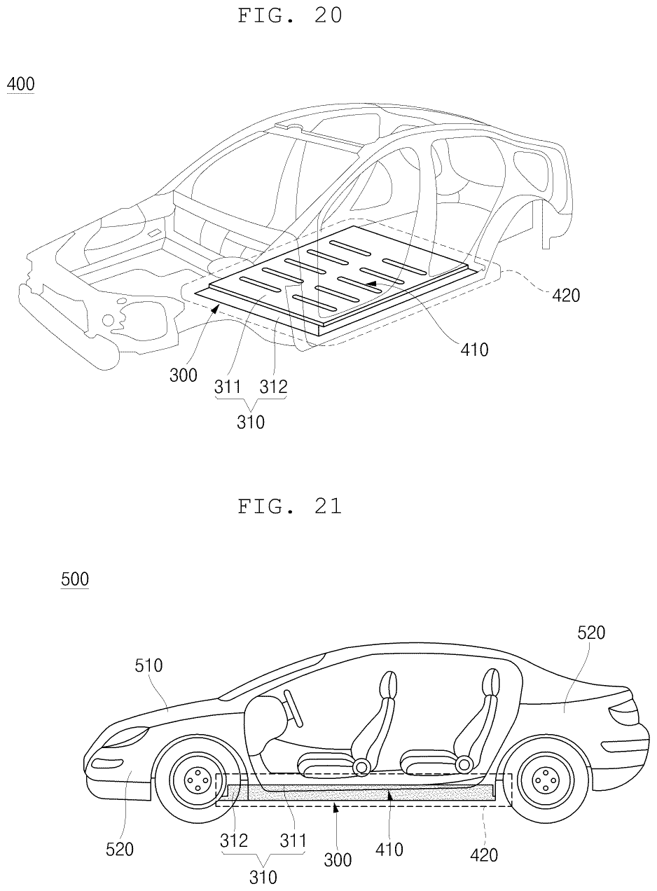

FIGS. 20 and 21 are, respectively, a perspective view and a side view showing vehicles 400 and 500 including the exemplary battery pack 300 according to the present disclosure.

In FIG. 20, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 21, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, according to the embodiments of the present disclosure, the arrangement and structure of electrode tabs in an electrode assembly is such that interference between the electrode tabs may be prevented and the quality of the electrode assembly during the winding process may be improved.

In addition, the overall thickness and size of the battery may be reduced by maximizing utilization of the internal space in the electrode assembly, thereby increasing energy density and enabling implementation of compact and lightweight secondary batteries.

Furthermore, by simplifying the connection structure between electrode tabs and electrode leads, the assembly process may be facilitated, and structural stability may be ensured. As a result, the secondary battery according to the present disclosure is applicable to various battery structures.

However, the effects achievable through the present disclosure are not limited to those described above, and other technical effects not mentioned can be clearly understood by those skilled in the art from the description of the disclosure provided above.

Although a few embodiments of the present disclosure have been shown and described, it would be appreciated by those skilled in the art that various changes and modifications may be made in this embodiment without departing from the principles and technical idea of the disclosure.

What is claimed is:

1. An electrode assembly comprising:
a first electrode plate;
a plurality of first electrode tabs connected to the first electrode plate;
a second electrode plate wound together with the first electrode plate about an axis that extends in a first direction; and
a plurality of second electrode tabs connected to the second electrode plate,
wherein the first electrode tabs do not to overlap each other in a second direction that is perpendicular to the first direction.

2. The electrode assembly as claimed in claim 1, wherein the second electrode tabs do not to overlap each other in the second direction.

3. The electrode assembly as claimed in claim 1, wherein the plurality of first electrode tabs comprises:
a first inner tab connected to the first electrode plate; and
a first outer tab spaced apart from the first inner tab and connected to the first electrode plate.

4. The electrode assembly as claimed in claim 3, wherein the plurality of second electrode tabs comprises:
a second inner tab connected to the second electrode plate; and
a second outer tab spaced apart from the second inner tab and connected to the second electrode plate.

5. The electrode assembly as claimed in claim 4, wherein the first inner tab and the second inner tab are disposed at a start of a winding of the electrode assembly.

6. The electrode assembly as claimed in claim 5, wherein the first outer tab and the second outer tab are disposed at an end of the winding of the electrode assembly.

7. The electrode assembly as claimed in claim 6, wherein the first inner tab and the second inner tab are spaced apart from each other by a distance of D1,
wherein the first outer tab and the second outer tab are spaced apart from each other by a distance of D2, and
wherein D1 is less than D2.

8. The electrode assembly as claimed in claim 6, wherein the first inner tab and the second inner tab are spaced apart from each other by a distance of D1,
wherein the first outer tab and the second outer tab are spaced apart from each other by a distance of D2. and
wherein D1 is greater than D2.

9. The electrode assembly as claimed in claim 6, wherein the first inner tab and the first outer tab are spaced apart from each other by a distance of D3 in a third direction that is perpendicular to the first and second directions,
wherein the second inner tab and the second outer tab are spaced apart from each other by a distance of D4 in the third direction, and
wherein D3 is equal to D4.

10. The electrode assembly as claimed in claim 1, wherein the electrode assembly is formed by winding the first electrode plate, the second electrode plate, and a separator, and the electrode assembly comprises an outer side comprising a flat surface as a planar region, and a rounded portion formed as a curved region, and
wherein the first electrode tabs and the second electrode tabs are disposed at positions overlapping the flat surface in the vertical direction.

11. A secondary battery comprising:
a case; and
an electrode assembly accommodated in the case, the electrode assembly being formed by winding a first electrode plate, a second electrode plate, and a separator about an axis that extends in a first direction, the electrode assembly comprising a plurality of first electrode tabs connected to the first electrode plate and a plurality of second electrode tabs connected to the second electrode plate,
wherein the first electrode tabs do not to overlap each other in a second direction that is perpendicular to the first direction, and
wherein the second electrode tabs do not to overlap each other in the second direction.

12. The secondary battery as claimed in claim 11, wherein the plurality of first electrode tabs comprises:
a first inner tab connected to the first electrode plate; and
a first outer tab spaced apart from the first inner tab and connected to the first electrode plate, and
wherein the plurality of second electrode tabs comprises:
a second inner tab connected to the second electrode plate; and
a second outer tab spaced apart from the second inner tab and connected to the second electrode plate.

13. The secondary battery as claimed in claim 12, comprising:
a connector connected to the first inner tab and the first outer tab; and
a lead electrically connected to the connector.

14. The secondary battery as claimed in claim 13, wherein one or more of the first inner tab and the first outer tab is bent into an L-shape or a V-shape.

15. The secondary battery as claimed in claim 13, wherein the lead is connected to a first side surface of the connector, and
wherein the first inner tab and the first outer tab are connected to a second surface of the connector that is opposite the first side surface.

16. The secondary battery as claimed in claim 13, wherein the lead, the first inner tab, and the first outer tab are connected to one of a first side surface and a second side surface of the first connector.

17. The secondary battery as claimed in claim 12, wherein one or more of the second inner tab and the second outer tab is bent into an L-shape or a V-shape.

18. The secondary battery as claimed in claim 12, comprising:
a connector connected to the second inner tab and the second outer tab; and
a lead electrically connected to the connector.

19. The secondary battery as claimed in claim 18, wherein the lead is connected to a first side surface of the second connector, and
wherein the second inner tab and the second outer tab are connected to a second side surface of the connector opposite the first side surface.

20. The secondary battery as claimed in claim 18, wherein the lead, the second inner tab, and the second outer tab are connected to one of a first side surface and a second side surface of the connector.
